(19) United States
(12) Patent Application Publication
(10) Pub. No.: US 2009/0144557 A1
(43) Pub. Date: Jun. 4, 2009

(54) RECOVERABLE SECURE DATA STORE SYSTEM AND METHOD

(75) Inventor: Matthew Sutton, Seattle, WA (US)

Correspondence Address: AXIOS LAW GROUP. PLLC, 1525 4TH AVE, STE 800, SEATTLE, WA, 98101-1648, US

(73) Assignee: HYBLUE, INC., Seattle, WA (US)

(21) Appl. No.: 12/181,302

(22) Filed: Jul. 28, 2008

Related U.S. Application Data
(60) Provisional application No. 60/981,787, filed on Oct. 22, 2007.
(60) Provisional application No. 60/952,082, filed on Jul. 26, 2007.

(51) Int. Cl. G06F 12/14; H04L 9/00; H04L 9/14

(52) U.S. Cl. 713/189; 380/44; 380/30

(57) ABSTRACT

A data security provision system and method are provided herein.

### RELATED REFERENCES

This application is a nonprovisional application of U.S. Provisional Application No. 60/981,787, filed Oct. 22, 2007; and of U.S. Provisional Application 60/952,082, filed Jul. 26, 2007. The contents of both provisional applications are incorporated herein by reference in their entirety.

### FIELD

The present invention relates to data security, and more particularly to a process for recoverably securing a data store on a device without enabling a security vendor to access the secured data.

### BACKGROUND

There are stories every day about lost or stolen laptop computers, mobile phones, and other devices containing sensitive information. For example, the Transportation Security Administration may lose a laptop with thousands of personal records. For another example, a business person may lose a mobile phone with sensitive trade secrets. Despite a variety of existing solutions to protect data on a laptop, these solutions are not in wide use.

In addition to laptops, other mobile devices, e.g., cellular telephones, are capable of storing large amounts of sensitive data. Whether for laptops, desktop computers, or other mobile devices, existing solutions generally break down into a few basic varieties:
Hardware keys to encrypt data on a hard disk
Login key generators linked to a central security server
Software keys to encrypt data on a hard disk
Encryption technologies built into certain versions of the Windows™ operating system made by Microsoft Corp. of Redmond, Wash.

Such solutions tend to require that the user take extra steps to access his or her data. For example, the user might need to insert a USB device or look up a login number from a login key generator.

If the files are encrypted on the disk or the entire hard disk is encrypted with a software solution, the user might need to remember a long, complex password that may change frequently to retain optimal security. Because complex passwords are more secure than easy to remember passwords, users need some way of remembering them. Consequently, security may be compromised when users write passwords on a label attached to the device that is supposed to be protected. These added steps make existing security solutions less desirable and functional for common computer users.

Moreover, installation, administration and support for existing systems may be very time consuming for system administrators. Users forget complex passwords, and installation and operation may also be expensive. Solutions that rely on external hardware devices tend to be expensive, and a lost hardware encryption device may bar recovery or require significant effort to recover encrypted data.

Another shortcoming of current systems is that if there is any kind of damage to a hard disk that keeps the computer from booting, the secured data is often lost, as stand alone systems typically do not have provisions for recovering data from a damaged, unbootable computer.

Additionally, many current systems represent a static threat block. That is, systems using encryption from a single vendor typically use a static set of encryption technologies. This means that if a hacker wants to find his way into the system, he or she simply needs to understand the system's encryption technologies. Once done, decrypting passwords is a known process.

Today's mobile phones are in essence mobile computing platforms. The existing solutions available to secure data on mobile phones are typically dependent on a simple local password to encrypt data and do not offer centralized control.

Many mobile phones offer encryption of data on a removable memory device. This encryption may be related to the mobile phone and the data encrypted thereon often cannot be read by an authorized user on any other device.

An unauthorized user might use multiple approaches to attempt to access secure data on a client device. For example, an unauthorized user might:
Attempt to login as an authorized user;
Login as an administrative user, change file permissions and then access the files;
Login as administrative user, change an authorized user's password and login as the authorized user using the new password;
Move a secure data store to a device with a different operating system;
Hack into a device via a network connection;
Boot the device into an alternate operating system and alter the password of an authorized user, subsequently logging in as the authorized user.

In addition, many existing security solutions are vulnerable to a “cold boot” attack, which potentially allows unauthorized users to steal encryption keys from dynamic RAM (DRAM) memory in computers and other devices that have been recently powered down. By cooling a computer's DRAM chips, such as with liquid nitrogen, the contents of the DRAM may be “frozen” for several minutes or longer, potentially allowing an unauthorized user to examine the DRAM's contents, including cryptographic keys used with disk-encryption products.

### BRIEF DESCRIPTION OF THE DRAWINGS

FIG. 1 is a system diagram of a number of devices in a network in accordance with one embodiment.

FIG. 2 is a diagram of components in a client device in accordance with one embodiment.

FIG. 3 is a diagram of components in a security server in accordance with one embodiment.

FIG. 4 is a diagram illustrating a conceptual overview of the various keys and constants associated with an entity-managed device in accordance with one embodiment.

FIG. 5 is a diagram illustrating generating sets of keys in accordance with one embodiment.

FIG. 6 is a diagram illustrating a Device Values_{(X,Y)} generation subroutine in accordance with one embodiment.

FIG. 7 is a diagram illustrating the creation of entity and device public and private keys in accordance with one embodiment.

FIG. 8 is a diagram illustrating steps taken to generate a device data key in accordance with one embodiment.

FIG. 9 is a data flow diagram of an entity registration process in accordance with one embodiment.

FIG. 10 is a data flow diagram illustrating a device installation process in accordance with one embodiment.

FIG. 11 is a diagram illustrating accessing encrypted data from a secure data store in accordance with one embodiment.

FIG. 12 is a data flow diagram illustrating generating an Ephemeral Key to decrypt a Device Data Key in accordance with one embodiment.

FIG. 13 is a diagram illustrating an exemplary process for monitoring one or more locking status indicators and purging sensitive data from transient storage in accordance with one embodiment.

FIG. 14 is a data flow diagram illustrating an exemplary sequence to disable and re-enable access to a secure data store when a device is stolen and recovered in accordance with one embodiment.

FIG. 15 is a data flow diagram illustrating a sequence by which one entity-managed device can access a secure data store from another entity-managed device in accordance with one embodiment.

### DESCRIPTION

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the embodiments discussed herein.

Described herein are methods and systems that
support varying device and connectivity types, including devices not connected to an external network as well as multiple users sharing a device;
provide a secured (encrypted) data storage volume for:
Computer Systems (desktops, laptops, servers); and
Smart Phones running operating systems including Symbian OS (produced by Symbian Ltd. of Southwark, London), Windows CE (produced by Microsoft Corporation of Redmond, Wash.), and OS X (produced by Apple Inc. of Cupertino, Calif.);
are easy to use, requiring minimal or no end user involvement (perhaps entering a password);
allow data at rest to remain secure even if moved to another machine;
provide access to data with information from multiple sources to unlock the volume encryption;
allow device users to optionally password protect the volume;
permit entities, with many devices, privileged access to recover encrypted data from any entity managed device even if that device has an optional password set; and
allow key management that does not store or otherwise escrow private keys, maintaining perfect forward security of the system and ensuring that a security vendor cannot recover the data.

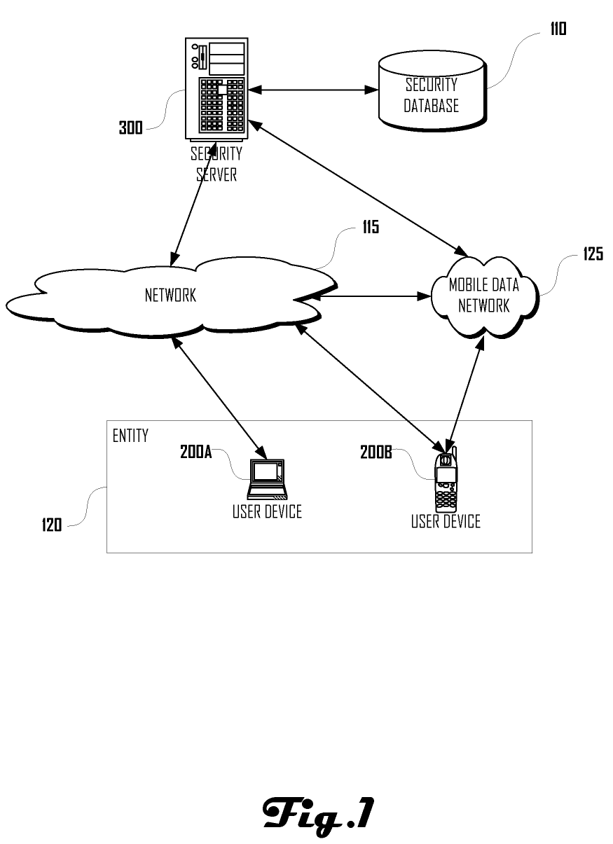

FIG. 1 illustrates an example scenario wherein various devices 200A-B and a security server 300 variously communicate via a network 115 and/or a mobile data network 125. In many embodiments, the network 115 may be the Internet, but the network 115 may also be a local area network (“LAN”), a wide area network (“WAN”), personal area network (“PAN”), or any other network that enables devices 200A-B to communicate with a security server 300. In some embodiments, network 115 may also be a one to one connection, such as a USB connection, a Bluetooth connection, or the like. The mobile data network 125 may utilize a Global System for Mobile communications (GSM) communication standard such as General Packet Radio Service (GPRS) or Enhanced Data rates for GSM Evolution (EDGE), a Universal Mobile Telecommunications System (UMTS) communication standard such as High Speed Packet Access (HSPA), a Code division multiple access (CDMA) communication standard, or the like.

A security server 300 may be a device that manages keys in the manner described herein. In an exemplary embodiment, the security server 300 may be operated by a third-party security vendor, but in alternate embodiments, the security server 300 could also be operated by the entity itself. In one exemplary embodiment, the security server 300 has access to a security database 110, in which certain key data may be stored, as described in detail below. The security database 110 may be implemented in any of countless methods that are well known in the art. In some embodiments, the security database 110 may be as simple as a single text file. In more sophisticated embodiments, the security database 110 may comprise a discrete secure server (not shown) operating a structured, queryable database.

An entity 120 is a person, organization, or organizational unit that may own and/or manage one or more client devices 200A-B. In some embodiments a user device 200 may be a personal computer, a game console, a set-top box, a handheld computer, a cellular telephone, a laptop computer, or any other device that can securely store data. A user related to the entity 120 typically operates user device 200 on a day-to-day basis. For example, a user device 200 may be operated by an employee of a company (the entity 120), a member of a club, a customer of a device or security vendor, a member of a family, or by any other who is related to some device-managing entity.

Although only two instances of user devices 200 and one security server 300 are illustrated, in some embodiments, more such devices and servers may be present. In some embodiments, functions of the security server 300 may be distributed across multiple devices (not shown).

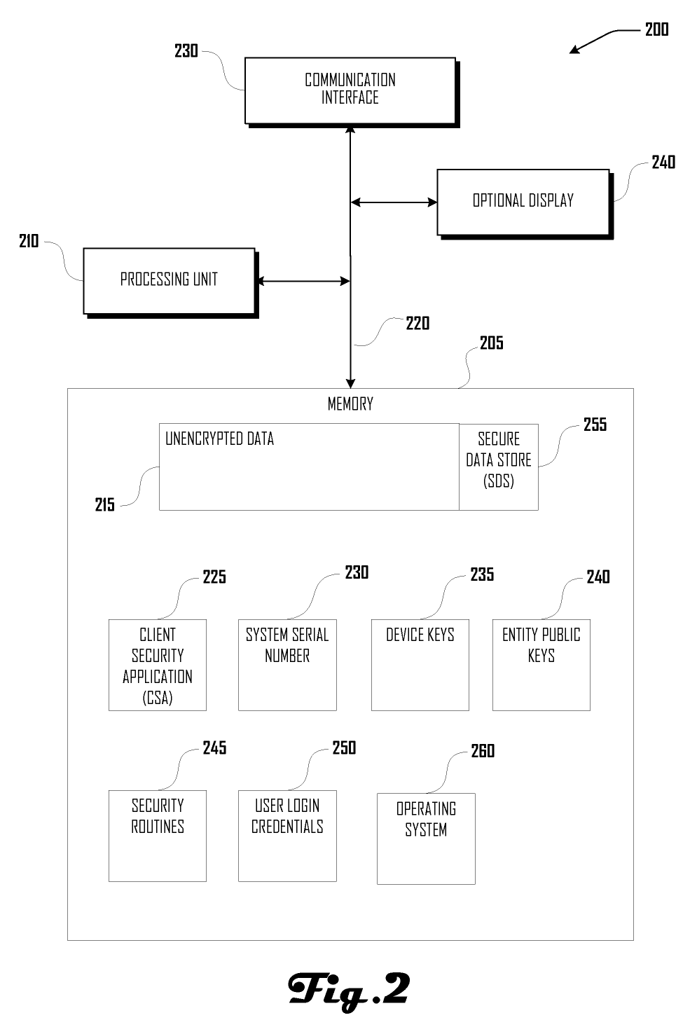

FIG. 2 illustrates several components of an exemplary user device 200. In some embodiments, the user device 200 may include many more components than those shown in FIG. 2. However, it is not necessary that all of these generally conventional components be shown in order to disclose an illustrative embodiment. As shown in FIG. 2, the user device 200 includes a communication interface 230 for connecting to the network 115, to a mobile data network 125, or to another communication network. Those of ordinary skill in the art will appreciate that the network interface 230 includes the necessary circuitry for such a connection and is constructed for use with the appropriate protocol(s).

The user device 200 also includes a processing unit 210, a memory 205, and may include an optional display 240, all interconnected along with the communication interface 230 via a bus 220. The memory 205 generally comprises transient storage, such as random access memory (“RAM”), a read only memory (“ROM”), and a persistent mass storage device, such as a disk drive or flash drive. The memory 205 stores program code for a client security application (CSA) 225 and security routines 245. In addition, the memory 250 also stores an operating system 260, user login credentials 250, a set of device keys 235, a set of device-specific entity public keys 240, unencrypted user data 215, and a secure data store 255. In some embodiments, memory 205 also stores a system serial number 230. It will be appreciated that these software components may be loaded from a computer readable medium into memory 250 of the user device 200 using a drive mechanism (not shown) associated with a computer readable medium, such as a floppy disc, tape, DVD/CD-ROM drive, memory card, via the network interface 230 or the like.

In one embodiment, secure data store (“SDS”) 255 is an encrypted file on a device's persistent storage device. In an exemplary implementation, a symmetric encryption algorithm may be used to encrypt the secure data store 255. Many appropriate symmetric encryption algorithms are known in the art, including Advanced Encryption Standard (AES), Data Encryption Standard (DES), Triple DES (3DES), Blowfish cipher, Serpent cipher, Twofish cipher, International Data Encryption Algorithm (IDEA), CAST-128 (alternatively CAST5) cipher, and the like. In alternate embodiments, asymmetric encryption algorithms may also be used to encrypt the secure data store 255. Many appropriate asymmetric encryption algorithms are known in the art, including RSA, Elliptic curve cryptography (ECC), and the like.

One or more of device keys 235 may be stored in encrypted form on user device 200. In an exemplary embodiment, an asymmetric encryption algorithm, such as those discussed above, is used to encrypt device keys 235 stored on user device 200. In an alternate embodiment, a symmetric algorithm may be used to encrypt device keys 235 stored on user device 200.

When correctly decrypted by the security routines 245, the SDS 255 may be configured to look like a virtual disk to the user. Without proper decryption, the SDS 255 may be a large data file full of useless data. In other embodiments, SDS 255 may occupy a separate logical or physical drive, or SDS 255 may occupy read-only or read-write removable media, such as removable magnetic media, removable optical media, a flash drive, or a removable data storage card. The systems and methods described herein are applicable to other formats of persistent storage that are yet to be developed.

Although an exemplary user device 200 has been described that generally conforms to conventional general purpose computing devices, those of ordinary skill in the art will appreciate that a user device 200 may be any of a great number of devices capable of communicating with the network 115, with a mobile data network 125, or with another communication network, and capable of storing a secure data store 255, devices including, for example, a personal computer, a game console, a set-top box, a handheld computer, a cell phone, or any other device that is capable of accessing on-line media.

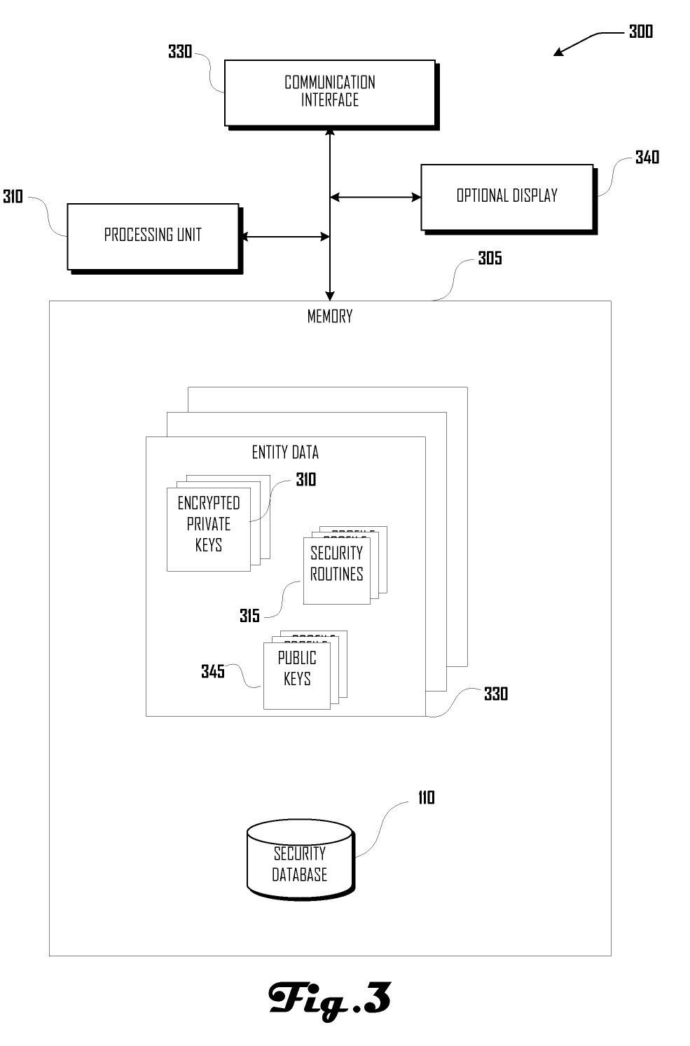

FIG. 3 illustrates several components of an exemplary security server 300. In some embodiments, the security server 300 may include many more components than those shown in FIG. 3. However, it is not necessary that all of these generally conventional components be shown in order to disclose an illustrative embodiment. As shown in FIG. 3, the security server 300 includes a communication interface 330 for connecting to the network 115, to a mobile data network 125, or to another communication network. Those of ordinary skill in the art will appreciate that the network interface 330 includes the necessary circuitry for such a connection and is constructed for use with the appropriate protocol.

The security server 300 also includes a processing unit 310, a memory 305, and may include an optional display 340, all interconnected along with the communication interface 330 via a bus 320. The memory 305 generally comprises a RAM, a ROM, and a persistent mass storage device, such as a disk drive or flash drive. Memory 305 may also comprise a security database 110 hosted locally or externally. The memory 305 stores entity data records 330 for one or more entities. Each entity data record 330 may include one or more sets of encrypted private keys 310, public keys 335, and security routines 315. In one embodiment, there is a set of public keys, encrypted private keys, and a security DLL associated with each user device 200 managed via the security server 300. In one embodiment, entity data records 330 are stored in a database accessible from the security server 300.

Although an exemplary security server 300 has been described that generally conforms to conventional general purpose computing devices, those of ordinary skill in the art will appreciate that a security server 300 may be any of a great number of devices capable of communicating with the network 115, with a mobile data network 125, or with another communication network.

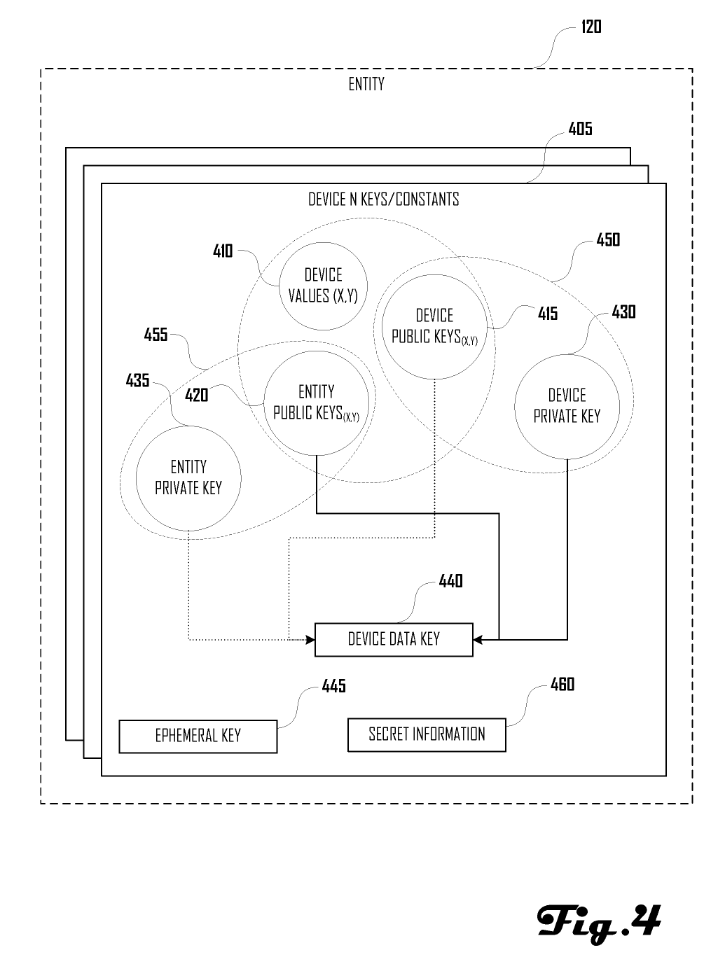

FIG. 4 illustrates a conceptual overview of the various keys and constants associated with an entity-managed device. Typically, an entity 120 manages one or more devices 200. For each such device managed by the entity, there exists a number of associated keys and constants 405. The details related to calculating/generating, storing, and using these sets of keys and constants 405 are detailed in figures that follow-FIG. 4 merely introduces an exemplary set of keys and relationships. In one embodiment, for each entity-managed device, there is a set of Device Keys 450 and a set of Entity Keys 455. In an exemplary embodiment, keys may be comprised and related as follows:
Device Keys 450 include a Device Private Key 430 and a related pair of Device Public Keys_{(X,Y)} 415;
Entity Keys 455 include an Entity Private Key 435 and a related pair of Entity Public Keys_{(X,Y)} 420; and
Device Public Keys_{(X,Y)} 415 and Entity Public Keys_{(X,Y)} 420 are related to Device Values (X,Y) 410.

The terms “Device . . . ” key and “Entity . . . ” key have no particular significance, except to provide convenient labels to clearly distinguish between two functionally related sets of keys. In one embodiment, the private key named Device Private Key 430 may be stored (in encrypted form) on user device 200, while the private key named Entity Private Key 435 may be stored (in encrypted form) off user device 200, for example on a different device managed by entity 120. In an exemplary embodiment, the set of Device Keys 450 are functionally interchangeable with the set of Entity Keys 455.

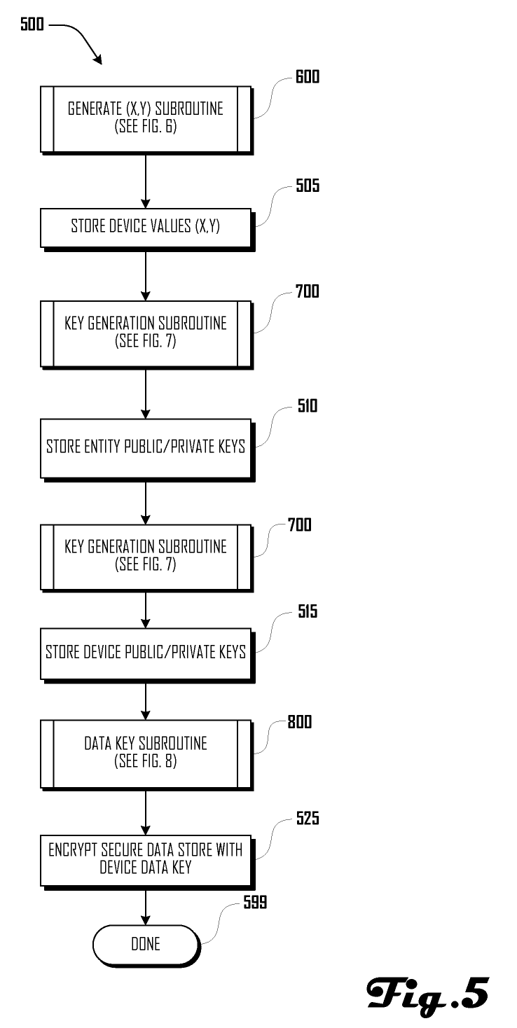

In an exemplary embodiment, for each device, a private key from one set of keys and a pair of public keys from the other set of keys can be used to generate a Device Data Key 440 that may be used to encrypt a secure date store 255 on the device. For example, in one embodiment, Device Private Key 430 and Entity Public Keys_{(X,Y)} 420 can be used to generate Device Data Key 440, but Entity Private Key 435 and Device Public Keys(X,Y) 415 can also be used to generate the same Device Data Key 440, as illustrated in FIG. 5 and described below.

In an exemplary embodiment, for each device there is also an Ephemeral Key 445, which may be used to encrypt the Device Data Key 440. In one exemplary embodiment, for each device there is also secret information 460, such as a password, passphrase, code, or the like, which may be used to encrypt one or both of Device Private Key 430 and Entity Private Key 435.

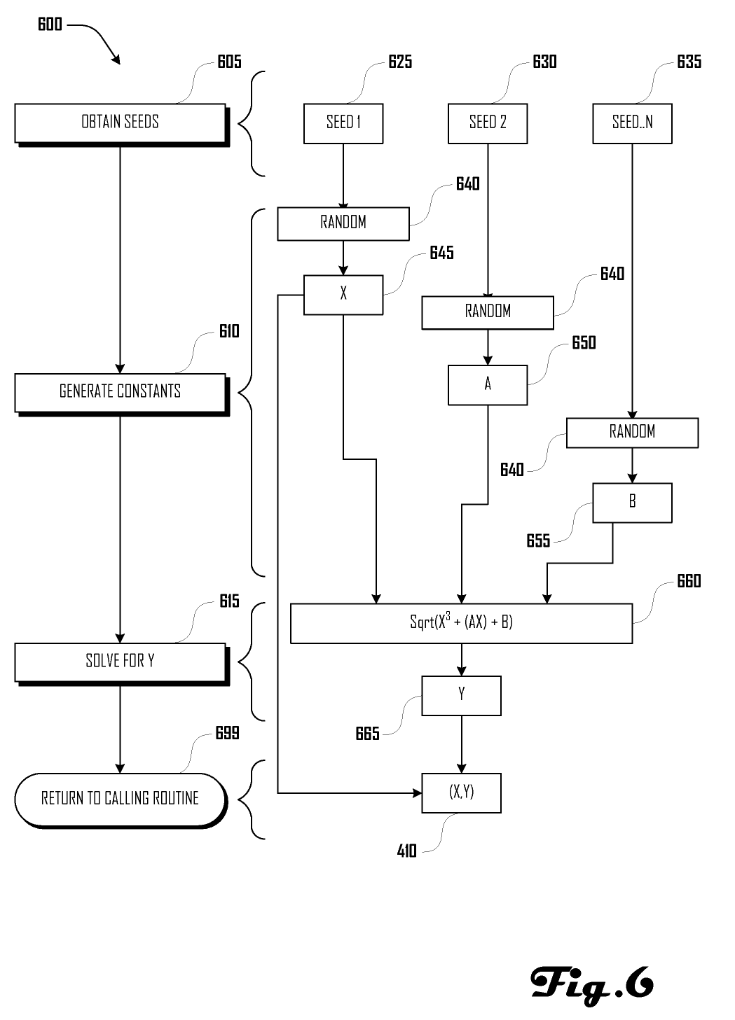

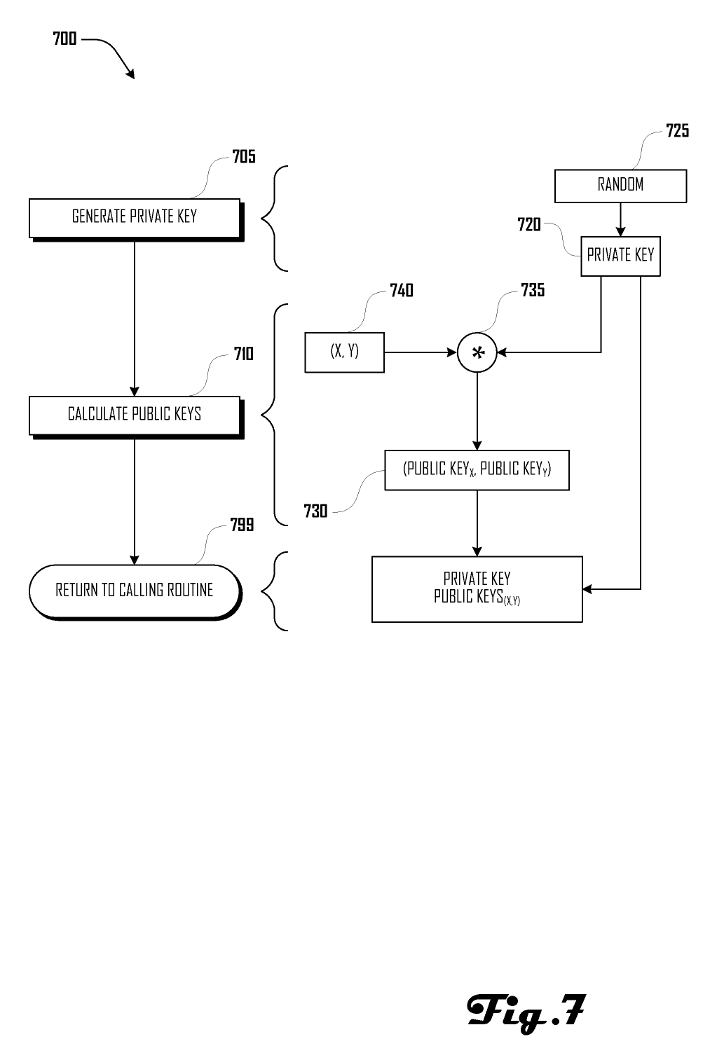

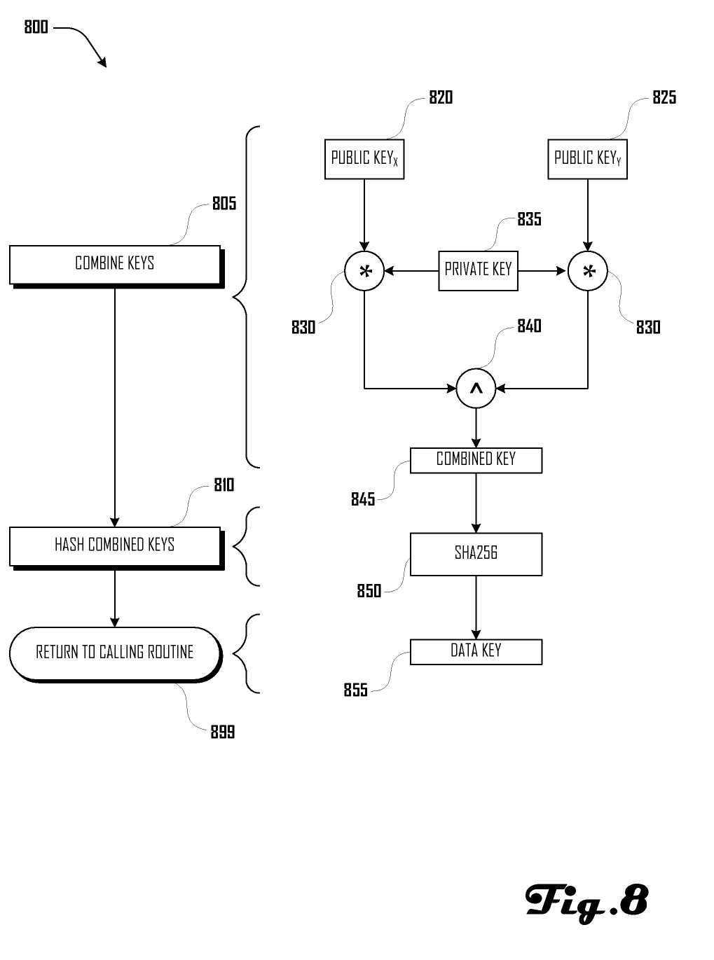

FIG. 5 illustrates an overview of a process of generating a set of Device Keys 450, a set of Entity Keys 455, and a Device Data Key 440 in accordance with one embodiment. In various embodiments (described below) the steps of routine 500 may be executed by multiple processing devices, at multiple points in time. The Generate (X,Y) subroutine 600, illustrated in FIG. 6 and described below, generates a pair of Device Values (X,Y) 410, which are temporarily stored in step 505. Next, the key generation subroutine 700, illustrated in FIG. 7 and described below, uses Device Values (X,Y) 410 to generate Entity Private Key 435 and a related pair of Entity Public Keys_{(X,Y)} 420, which are at least temporarily stored in step 510. The key generation subroutine 700 is executed again, to generate a Device Private Key 430 and a related pair of Device Public Keys_{(X,Y)} 415, which are at least temporarily stored in step 515. Next, the data key subroutine 800, illustrated in FIG. 8 and described below, calculates a device data key 440, which is used in step 525 to encrypt a secure data store. The process ands at step 599.

FIG. 6 illustrates an exemplary Device Values_{(X,Y)} 410 generation subroutine 600. In step 605, a number of random seeds 625-35 are obtained. Seeds may be obtained in a variety of ways. For example, a seed may be generated by a random number generator, a seed may be derived from a serial number or other unique ID, a seed may be chosen by a user, or the like. Seeds 625-35 may be generated internally or may be obtained from an external source. In one embodiment, an entity 120 chooses at least Seed1 625 and transmits it to a security server 300 for further processing. In alternate embodiments, one or more seeds may also be passed into the subroutine 600 as inputs. In step 610, a number of constants are generated. In one embodiment, seeds 625-35 are used in step 610 as inputs to a random number subroutine 640 to generate a corresponding number of constants, here named X 645, A 650, and B 655. In step 625, an additional constant may be derived. In one embodiment, Y 665 may be derived using one or more of X 645, A 650, and B 655. For example, Y 665 may be derived by solving a polynomial equation 660, for example, \sqrt{x³+ax+b}, which step 615 may be performed on a user device 200. In step 699, calculated values, such as Device Values (X,Y) 410, are returned to the calling routine.

FIG. 7 illustrates an exemplary subroutine 700 to calculate a set of related public and private keys, such as Device Private Key 430 and Device Public Keys_{(X,Y)} 415, or Entity Private Key 435 and Entity Public Keys_{(X,Y)} 420. In step 705, a private key 720 is generated. In one embodiment, private key 720 is generated using a random number generator 725. In some embodiments, random number generator 725 may be seeded in a manner similar to that described above, in regard to FIG. 6. Private key 720 may also be generated in any number of other ways known in the art. For example, private key 720 may be obtained by sampling a chaotic noise source or by requesting a value from a user. In step 710 one or more public keys are generated. In one embodiment, a pair of public keys_{(x,y)} 730 may be calculated by multiplying the private key 720 by a pair of inputs (X,Y) 740 (e.g., device values X,Y 410) that were passed into the subroutine 700. In other embodiments, more or fewer public keys may be calculated, and public keys may be calculated according to alternate formulas. For example, public keys may be calculated by obtaining a random number. In step 799, calculated keys, such as private key 720 and public keys_{(x,y)} 730, are returned to the calling routine.

FIG. 8 illustrates an exemplary data key generation subroutine 800. In step 805, a set of input keys are combined. In one embodiment, a pair of public keys 820-25 are multiplied 830 by a private key 835, and the results are concatenated 840 together. Other methods of combination are expressly contemplated. For example, in alternate embodiments, the results could be added or multiplied together. In an exemplary embodiment, the pair of public keys 820-25 are Entity Public Keys(X,Y) 420 and the private key 835 is Device Private Key 430. In an alternate embodiment (for example, when a lost data key must be recovered), the pair of public keys 820-25 may be Device Public Keys(X,Y) 415 and the private key 835 may be Entity Private Key 435. In step 810, combined key 845 is hashed according to any suitable method known in the art. In one embodiment, combined key 845 is hashed according to the SHA256 algorithm 850. In step 899, the resulting data key 855 is returned to the calling routine.

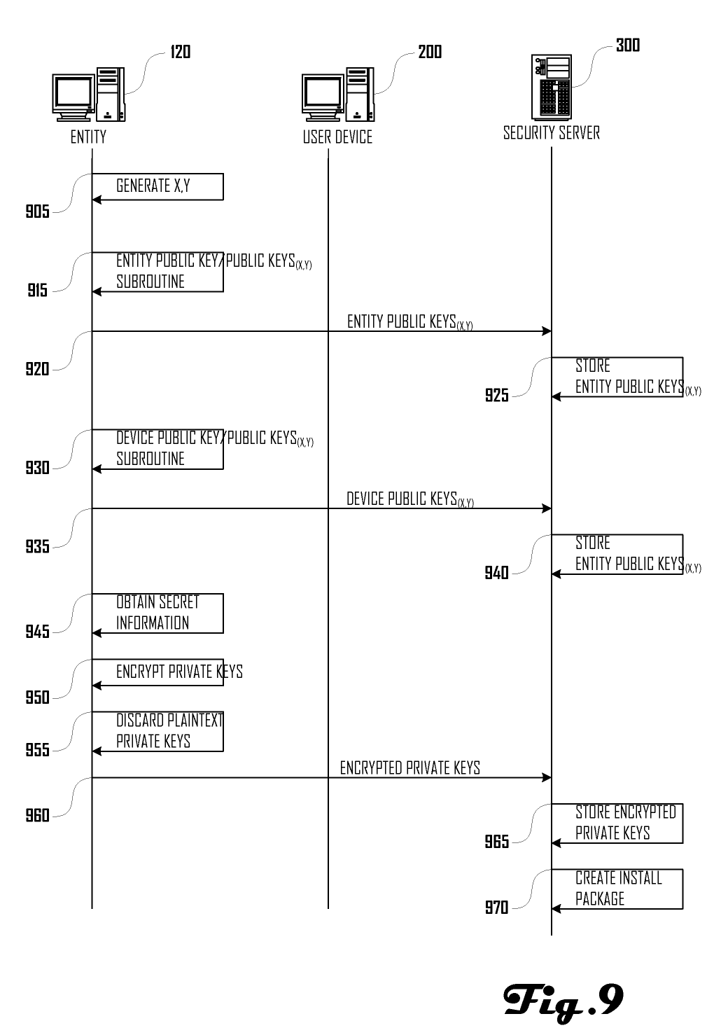

FIG. 9 illustrates an exemplary data flow that may take place when a user device 200 is registered. An entity 120 may wish to create a set of keys to secure data on a user device 200 managed by the entity 120. Initially Device Values (X,Y) 410 are generated 905. In one embodiment, subroutine 600 generates Device Values (X,Y) 410. The entity generates 915 a set of Entity Keys 455, including Entity Private Key 435 and Entity Public Keys_{(X,Y)} 420. In one embodiment, subroutine 700 generates 915 the set of Entity Keys 455. In one embodiment, Entity Public Keys_{(X,Y)} 420 may be transmitted 920 to a security server 300 to be stored 925.

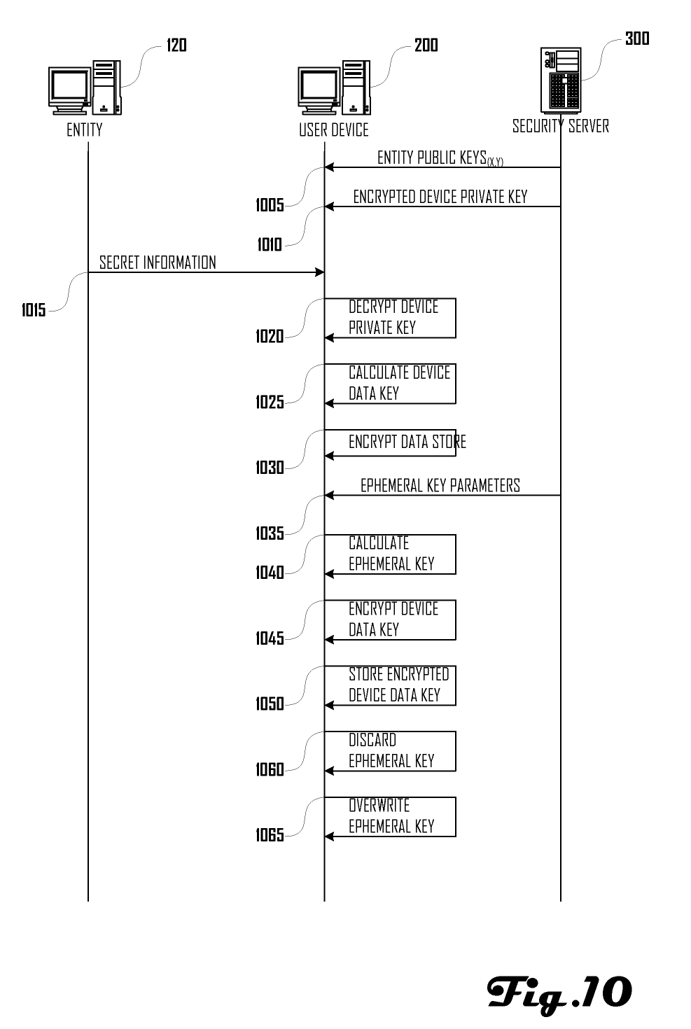

Entity 120 also generates a set of Device Keys 450, including Device Private Key 430 and Device Public Keys_{(X,Y)} 415. In one embodiment, subroutine 700 generates 915 the set of Device Keys 450. In one embodiment, Device Public Keys_{(X,Y)} 415 may be transmitted 935 to a security server 300 to be stored 940. Entity 120 obtains 945 secret information 460, such as a password, passphrase, or other information known to entity 120. In one embodiment, secret information 460 is not shared with security server 300. Secret information 460 is used to encrypt 950 Device Private Key 430, after which the unencrypted Device Private Key 430 is discarded 955. In an exemplary embodiment, unencrypted Device Private Key 430 and Entity Private Key 435 are never known to security server 300. In some embodiments, encrypted Device Private Key 430 and encrypted Entity Private Key 435 may be stored by entity 120 and/or transmitted 960 to security server 300 to be stored 965. In some embodiments, security server 300 may create 970 a package that may be sent to and installed on a user device 200. Such a package may include one or more sets of public keys, or such a package may include instructions to enable a user device 200 to obtain a set of keys from security server 300, as illustrated in FIG. 10 and described below.

FIG. 10 illustrates a data flow of an exemplary device installation process. User device 200 receives 1005, 1010 a pair of Entity Public Keys(X,Y) 420 and an encrypted Device Private Key 430. In one embodiment, Entity Public Keys(X,Y) 420 and an encrypted Device Private Key 430 are received 1005, 1010 via an installer package. In another embodiment, user device 200 requests Entity Public Keys(X,Y) 420 and an encrypted Device Private Key 430 from security server 300 via a network 115, 125. User device 200 may obtain 1015 secret information 460 from entity 120 in any number of ways. For example, a representative of entity 120 may enter secret information 460 via a keyboard or other input device. Secret information 460 may also be transmitted to user device 200 via a network 115, 125, via a data storage device, or via any similar method.

Using secret information 460, user device 200 may decrypt 1020 the Device Private Key 430. User device 200 is then able to calculate 1025 a Device Data Key 440. In one embodiment, user device 200 uses subroutine 800 to calculate 1025 Device Data Key 440. In some embodiments, the user operating user device 200 may also be given the opportunity to create and/or copy data to a secure data store 255. Using Device Data Key 440, user device 200 encrypts 1030 data in the secure data store 255.

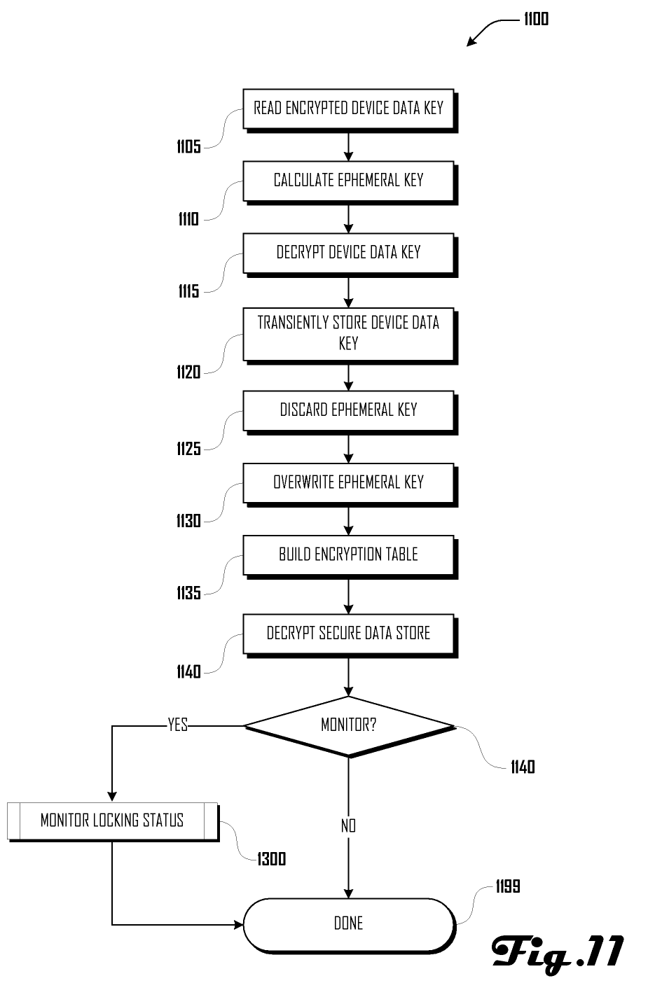

Device Data Key 440 is not stored in clear form on user device 200. In one embodiment, Device Data Key 440 is encrypted using an Ephemeral Key 445 that may be constructed using a predetermined method from various predetermined components or elements. In one embodiment, Ephemeral Key 445 is never persistently stored, but can be reproducibly calculated, given the proper set of predetermined elements. An exemplary Ephemeral Key generation process is illustrated in FIG. 11. To calculate the Ephemeral Key 445, user device 200 must obtain 1035 a set of ephemeral key parameters, including a method to combine various predetermined elements. User device 200 may obtain 1035 these parameters from security server 300 via a network 115, 125, via an installer package, or via any other suitable method. Device is then able to calculate 1040 the Ephemeral Key 445 and encrypt 1045 Device Data Key 440. Device stores 1050 the encrypted Device Data Key 440. Ephemeral Key 445 may then be discarded 1060. In one embodiment, the location in memory where Ephemeral Key 445 had been stored may then be overwritten 1065 one or more times with random or other data to thwart a “cold boot” attack.

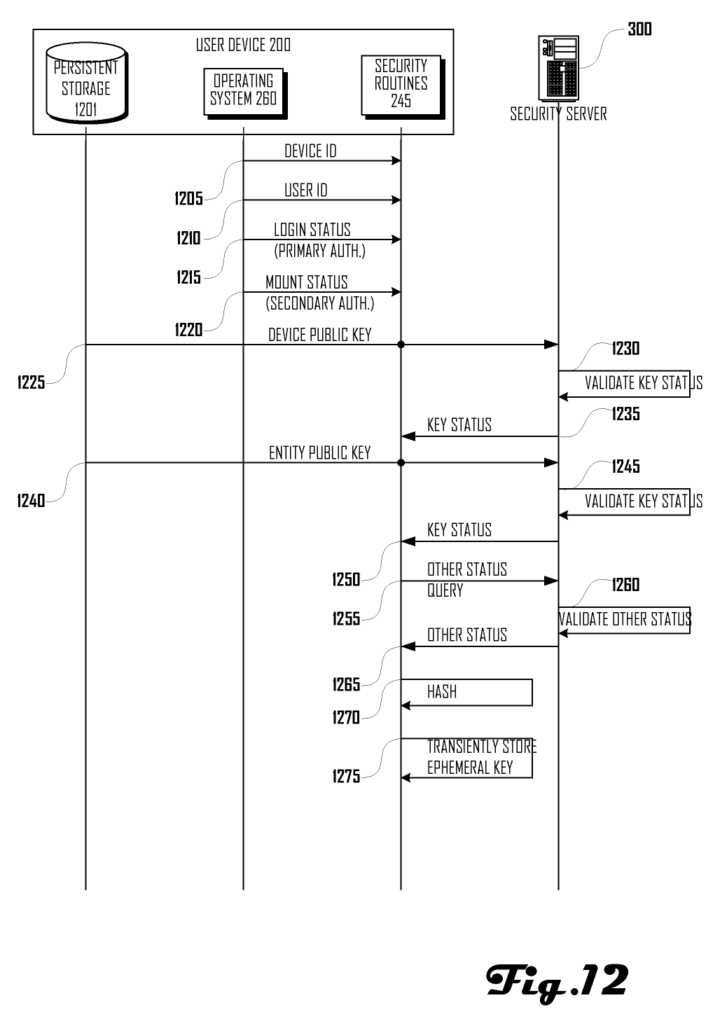

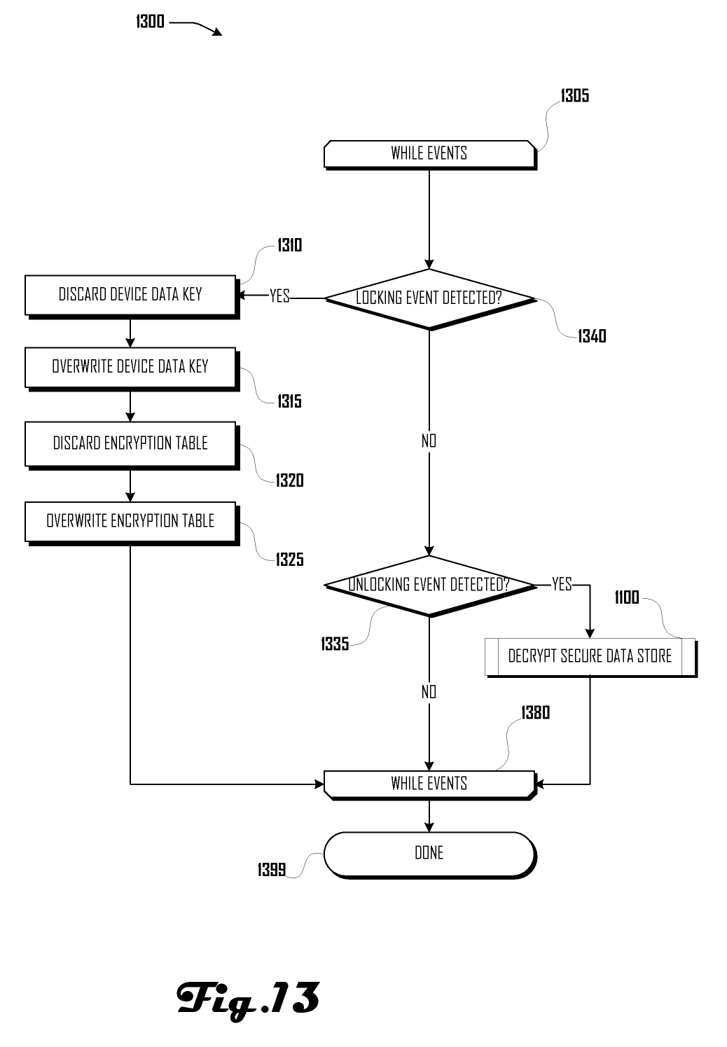

FIG. 11 illustrates an exemplary process of accessing encrypted data from a secure data store 255. In step 1105, the user device 200 reads an encrypted Device Data Key 440, typically from a persistent storage device. In alternate embodiments, encrypted Device Data Key 440 may be obtained from a transient storage location, from a removable storage device, from security server 300 via a network 115, 125, and the like. In step 1110, an Ephemeral Key 445 is calculated and stored into transient memory long enough for it to be used in step 1115. A detailed illustration of calculating an Ephemeral Key 445 according to one embodiment is illustrated in FIG. 12. In step 1115, the encrypted Device Data Key 440 is decrypted with the Ephemeral Key 445. In step 1120, the decrypted Device Data Key 440 is transiently stored. In step 1125, Ephemeral Key 445 is discarded without having been persistently stored or transmitted. In one embodiment, the location in transient memory in which Ephemeral Key 445 was stored is overwritten one or more times with random or other data to thwart a cold boot attack, as in step 1130. In some embodiments, step 1135 may be employed to build and transiently store an encryption table. In step 1140, data from the secure data store 255 is decrypted. In one embodiment, the secure data store 255 is decrypted using the decrypted Device Data Key 440. In other embodiments, the encryption table built in step 1135 may be used to decrypt data from the secure data store 255, instead of or along with the Device Data Key 440. In decision block 1140, it is determined whether to monitor for locking/unlocking events. If no monitoring is to occur, the process ends at step 1199. If monitoring is to occur, locking/unlocking events are monitored in subroutine 1300, as illustrated in FIG. 13 and described below.

FIG. 12 illustrates a data flow of accessing data in a secure data store 255 by generating an Ephemeral Key 445 to decrypt a Device Data Key 440, in accordance with one embodiment. In other embodiments, more or fewer elements may be combined in various ways to generate Ephemeral Key 445. In an exemplary embodiment, the security routines 245 (software or hardware) mediate access to data on a secure data store 255, which exists on persistent storage 1201 associated with user device 200. An operating system 260 on user device 200 may mediate or provide access to various elements that are combined to generate Ephemeral Key 445.

In one embodiment, the security routines 245 obtain some or all of the following elements from operating system 260:
a device ID 1205, such as a processor serial number, MAC address, or a similar unique identifier associated with a hardware or software component of user device 200;
a user ID 1210, such as a login name, a user number, or other identifier associated with a user of user device 200;
a login status 1215, which may indicate that a user of user device 200 has successfully passed a primary authentication test, such as providing a user password, and been granted access to user device 200; and
a mount status 1220, which may indicate that a secondary authentication test has been successfully passed (e.g., a secondary password may be required to mount secure data store 255 as a virtual drive).

In an exemplary embodiment, the calculation of Ephemeral Key 445 does not incorporate a user password, a secondary password, or any other passwords. Rather, in an exemplary embodiment, the calculation of Ephemeral Key 445 may incorporate only one or more status flags, indicating that one or more authentication tests (such as entering a password) have been passed. Thus, in an exemplary embodiment, the calculation of Ephemeral Key 445 may not directly involve a password evaluation step, nor is a password directly incorporated into Ephemeral Key 445. In this manner, the security of Ephemeral Key 445 may not be directly compromised if a password is weak or is acquired by an unauthorized user.

The security routines 245 may also obtain 1225 one or more public keys associated with user device 200. In an exemplary embodiment, the security routines 245 obtain 1225 Device Public Keys_{(X,Y)} 415. In some embodiments, the public keys are passed on to security server 300 to be validated 1230 to ensure that they have not been revoked (for example, user device 200 may receive a status flag from security server 300 indicating that the user device 200 has been stolen, in which case, the user device 200 may revoke its public keys). Security server 300 returns 1235 the validation status of the public keys. In one embodiment, one or more second public keys (e.g., Entity Public Keys_{(X,Y)} 420) may be obtained 1240 and validated 1245 in a similar fashion. The validation status of a second public keys is returned 1250 to user device 200.

In some embodiments, the security routines 245 may make one or more additional status queries 1255 to security server 300. For example, security server 300 may be queried 1255 to determine whether user device 200 has been reported as stolen or damaged, whether user device 200 is currently licensed to use security software, and the like. Security server 300 validates 1260 any other status queries and returns 1265 query statuses to user device 200.

The security routines 245 combine all predetermined elements and hashes 1270 the combination to obtain the Ephemeral Key 445. In one embodiment the SHA256 algorithm is used. Ephemeral Key 445 is transiently stored 1275 so that it can be used to decrypt an encrypted Device Data Key 440.

FIG. 13 illustrates an exemplary process for further enhancing the security of a secure data store 255 by monitoring one or more status indicators or events to determine whether transiently stored sensitive data should be purged from transient storage. In beginning loop block 1305, one or more status indicators or events are monitored. Exemplary locking events include the following:
Screen saver activated;
Sleep mode activated;
Hibernation mode activated;
Standby mode activated;
User logged off;
Device halted (e.g., user device 200 has been directed to shut down);
Device idle (e.g., no user input detected for a period of time).

Generally speaking, an unlocking event corresponds to the inverse of a locking event. For example, unlocking events include the following:
Screen saver de-activated;
Sleep mode de-activated;
Hibernation mode de-activated;
Standby mode de-activated;
User logged on;
Device started;
Device active (e.g., user input detected).

In addition, a user device 200 may also periodically request a status update from a security vendor 300, for example to determine whether user device 200 has been reported stolen or whether user device 200 is properly licensed with security vendor 300. A security vendor 300 may also transmit a locking or an unlocking event to a user device 200 via a network 115, 125.

If a locking event is detected in decision block 1340, steps may be taken to purge sensitive data that may be stored in transient memory. Purging such data may help to thwart a cold boot attack. In step 1310, the decrypted Device Data Key 440 is discarded from transient storage. In step 1315, the location in transient storage where Device Data Key 440 had been stored is overwritten one or more times with random or other data. In embodiments that use one or more encryption tables, in step 1320, any encryption tables are discarded from transient storage, and in step 1325, locations in transient storage where encryption tables had been stored are overwritten one or more times with random or other data. Thus, when a locking event is detected, access to the secure data store 255 is blocked.

If no locking event is detected in decision block 1340, decision block 1335 determines whether an unlocking event is detected. If an unlocking event is detected 1335, the secure data store is decrypted 1100 according to the steps illustrated in FIG. 11. Otherwise the routine loops back from loop block 1380 to 1305 if there are more events to monitor. If no more events are to be monitored, the routine ends at 1399.

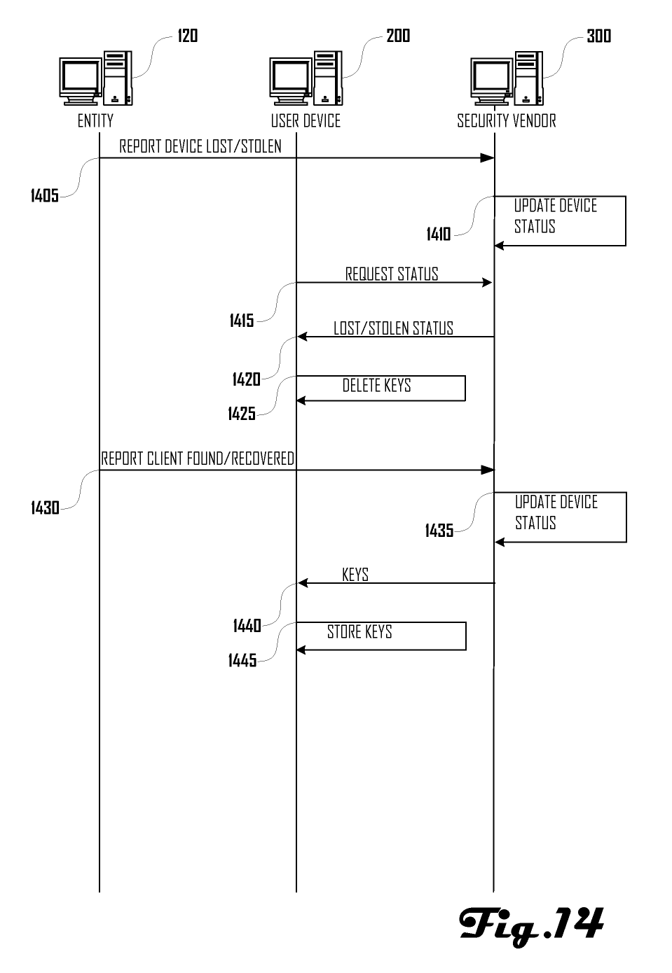

FIG. 14 is a data flow diagram illustrating an exemplary sequence to disable and re-enable access to a secure data store 255 when a user device 200 is stolen and recovered. Entity 120 reports 1405 to security vendor 300 that user device 200 has been lost or stolen. Security vendor 300 updates 1410 user device 200 status. User device 200 requests 1415 a status update from security vendor 300, for example, because user device 200 makes periodic status checks, because the security routines 245 attempt to generate an Ephemeral Key 445, or for a similar reason. Security vendor 300 sends 1420 a status indicating user device 200 has been lost or stolen. In response, the security routines 245 delete 1425 public keys from persistent storage on the User Device 200 as if a locking event has been detected. The security routines 245 may also overwrite the deleted files with random or other data. The security routines 245 may also delete some or all components of the security routines 245. The security routines 245 may take similar steps in other circumstances, for example, if they detect that an unauthorized user is attempting to access user device 200 or the secure data store 255 hosted thereon.

When entity 120 reports 1430 that user device 200 has been recovered, security vendor 300 updates 1435 user device 200 status and transmits 1440 copies of any public keys and/or security software components that were deleted when user device 200 was reported as lost or stolen. Device stores 1445 the received data, thereby re-enabling access to secure data store 255 by an authorized user.

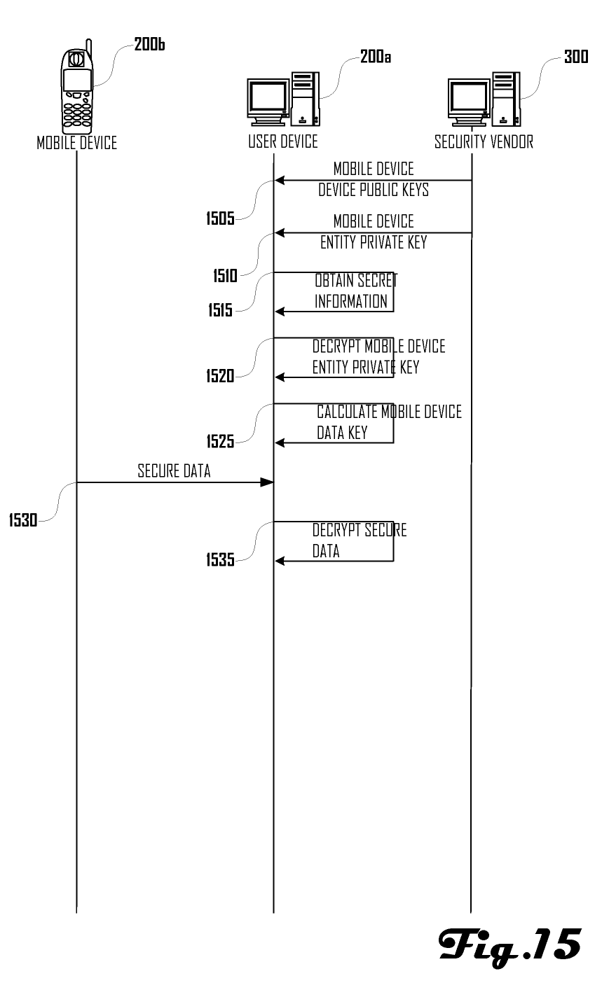

FIG. 15 illustrates a data flow of an exemplary sequence by which one entity-managed user device 200A can access a secure data store 255 from another entity-managed user device 200B. For example user device 200B may be a mobile phone having a secure data store 255. A user may wish to access secure data from the mobile phone 200B on, for example, a desktop computer 200A via a connection method. For example, mobile phone 200B may be connected to desktop computer 200A via a shared removable data card, wired or wireless USB, Bluetooth, network file sharing, or the like. Desktop computer 200A may have access to mobile phone 200B's encrypted Device Data Key 440. However, because desktop computer 200A will not have access to the proper set of identifiers and other elements, desktop computer 200A will be unable to generate the proper Ephemeral Key 445 to decrypt mobile phone 200B's encrypted Device Data Key 440. Desktop computer 200A may have access to its own Device Data Key 440, but desktop computer 200A's Device Data Key 440 cannot decrypt data on mobile phone 200B's secure data store 255.

But desktop computer 200A can access mobile phone 200B's secure data store if desktop computer 200A can independently generate mobile phone 200B's Device Data Key 440. Accordingly, desktop computer 200A receives 1505 (e.g., from security vendor 300) mobile phone 200B's Device Public Keys_{(X,Y)} 415. Desktop computer 200A also receives mobile phone 200B's encrypted Entity Private Key 435. Desktop computer 200A obtains 1515 the secret information 460 that was used to encrypt mobile phone 200B's Entity Private Key 435. For example, this secret information 460 may be known to a user who operates both mobile phone 200B and desktop computer 300. Using this secret information 460, desktop computer 200A decrypts 1520 mobile phone 200B's Entity Private Key 435. Using mobile phone 200B's decrypted Entity Private Key 435 and mobile phone 200B's Device Public Keys_{(X,Y)} 415, desktop computer 200A calculates mobile phone 200B's Device Data Key 440 according to, for example, subroutine 800. After obtaining 1530 secure data from mobile phone 200B, desktop computer 200A uses the calculated mobile phone 200B Device Data Key 440 to decrypt 1535 the secure data.

A similar process could be utilized in other circumstances, for example, if a device is damaged and its secure data store 255 must be recovered from a recovery computer.

Although specific embodiments have been illustrated and described herein, it will be appreciated by those of ordinary skill in the art that a whole variety of alternate and/or equivalent implementations may be substituted for the specific embodiments shown and described without departing from the scope of the present invention. This application is intended to cover any adaptations or variations of the embodiments discussed herein.

1. A computer-implemented method of securing a data store on a device managed by an entity, the method comprising:
obtaining an encrypted device private key;
obtaining a pair of entity public keys;
obtaining secret user information;
decrypting said encrypted device private key with said secret user information;
calculating a device data key, in accordance with data key calculation values comprising said device private key and said pair of entity public keys; and
encrypting the data store using said device data key.

2. The method of claim 1, wherein said encrypting the data store comprises symmetrically encrypting the data store.

3. The method of claim 1, wherein the data store comprises a selected one of a file, a directory, a drive image, or a drive.

4. The method of claim 1, further comprising:
reproducibly calculating an ephemeral key in accordance with a predetermined plurality of elements;
re-encrypting said device data key using said ephemeral key;
storing said re-encrypted device data key, to enable the re-encrypted device data key to be decrypted by re-calculating said ephemeral key when said predetermined plurality of elements are reproduced; and
discarding said ephemeral key without persistently storing or transmitting it.

5. The method of claim 4, wherein at least one of said predetermined plurality of elements is selected from among a device-specific identifier, a user-specific identifier, a password entry status, a secondary authentication status, a licensing status, a device integrity status, and a public key revocation status.

6. The method of claim 4, further comprising overwriting data to a location where said ephemeral key had been transiently stored.

7. The method of claim 4, wherein storing said re-encrypted device data key comprises locally storing said re-encrypted device data key to enable access to the encrypted data store without reference to externally stored information.

8. The method of claim 4, wherein:
said data key calculation values do not comprise a password; and
said predetermined plurality of elements does not comprise a password.

9. A computer readable medium having stored thereon instructions that, when executed, perform the method of claim 1.

10. A computer apparatus having a processor and memory containing computer executable instructions that, when executed by the processor, perform the method of claim 1.

11. A computer implemented method of decrypting a secure data store on a device, the method comprising:
obtaining in an encrypted form, a data key used to encrypt the secure data store;
calculating an ephemeral key in accordance with a predetermined plurality of elements;
transiently storing said ephemeral key in a first transient storage location;
decrypting said encrypted data key using said ephemeral key;
discarding, without persistently storing or transmitting, said ephemeral key;
transiently storing said decrypted data key in a second transient storage location; and
decrypting said secure data store using the decrypted data key.

12. The method of claim 11, wherein the secure data store comprises a selected one of a file, a directory, a drive image, or a drive.

13. The method of claim 11, further comprising overwriting data to said first transient storage location.

14. The method of claim 11, wherein at least one of said predetermined plurality of elements is selected from among a device-specific identifier, a user-specific identifier, a login identifier, a password entry status, a secondary authentication status, a licensing status, a device integrity status, and a public key revocation status.

15. The method of claim 11, wherein:
said data key was not calculated in accordance with a password; and
said predetermined plurality of elements does not comprise a password.

16. The method of claim 11, further comprising:
monitoring the device for a first device status change; and
when said first device status change occurs, discarding, without persistently storing or transmitting, said decrypted data key; and
overwriting data to said second transient storage location.

17. The method of claim 16, further comprising:
monitoring the device for a second device status change; and
when said second device status change occurs:
recalculating said ephemeral key;
decrypting said encrypted data key using said ephemeral key; and
discarding, without persistently storing or transmitting, said ephemeral key.

18. The method of claim 16, further comprising:
transiently storing an encryption table in a fourth transient storage location; and
when said first device status change occurs,
discarding, without persistently storing or transmitting, said encryption table; and
overwriting data to said fourth transient storage location.

19. The method of claim 17, further comprising transiently storing an encryption table when said second device status change occurs.

20. The method of claim 16, wherein the monitored device status comprises a selected one of a remotely-obtained locking status, a locally-generated locking status, a login status, a sleep status, a standby status, a power status, an idle status, or a screen saver status.

21. A computer readable medium having stored thereon instructions that, when executed, perform the method of claim 11.

22. A computer apparatus having a processor and memory containing computer executable instructions that, when executed by the processor, perform the method of claim 11.

23. A computer-implemented method of managing a secure data store on a device managed by an entity, the method comprising:
obtaining a first device value and a second device value;
generating a device private key;
obtaining secret user information;
encrypting with said secret user information said device private key;
discarding, without storing or transmitting, said device private key;
storing said encrypted device private key;
calculating a pair of device public keys calculated in accordance with said first device value, said second device value and said device private key;
storing said pair of device public keys;
calculating a pair of entity public keys calculated in accordance with said first device value, said second device value and an entity private key, wherein said pair of entity public keys is related to said pair of device public keys; and
storing said pair of entity public keys.

24. The method of claim 23, wherein obtaining said second device value comprises mathematically deriving said second device value from said first device value via solving a polynomial equation.

25. The method of claim 23, further comprising generating a set of instructions that, when executed on the device, perform a method comprising:
obtaining said encrypted device private key;
obtaining said pair of entity public keys;
calculating a device data key in accordance with said data key calculation values; and
encrypting the secure data store using said device data key.

26. The method of claim 23, further comprising calculating a device data key, in accordance with said device private key and said pair of entity public keys.

27. A computer readable medium having stored thereon instructions that, when executed, perform the method of claim 23.

28. A computer apparatus having a processor and memory containing computer executable instructions that, when executed by the processor, perform the method of claim 23.
